(19) United States
(12) Patent Application Publication
(10) Pub. No.: US 2011/0086122 A1
(43) Pub. Date: Apr. 14, 2011

(54) DETACHABLE PUNCH MOLD

(75) Inventor: SUI-JING CAI, Shenzhen City (CN)

(73) Assignees: HONG FU JIN PRECISION INDUSTRY (ShenZhen) CO., LTD, Shenzhen City (TW); HON HAI PRECISION INDUSTRY CO., LTD., Tu-Cheng (TW)

(21) Appl. No.: 12/697,218

(22) Filed: Jan. 30, 2010

(30) Foreign Application Priority Data
Oct. 13, 2009 (CN) 200910308218.2

(51) Int. Cl. B29C 33/20

(52) U.S. Cl. 425/195

(57) ABSTRACT

A detachable punch mold includes a mold base, a clamp member, a punch, and a fastening member for securing the clamp member and the punch to the mold base. The clamp member defines a slot therein. The punch is partially engaged in the slot of the clamp member and partially protruding out from the clamp member. Both of the clamp member and the punch are detachably attached to the mold base.

### BACKGROUND

1. Technical Field

The present disclosure relates to a detachable punch mold.

2. Description of Related Art

Referring to FIG. 4, a typical punch mold includes a cylindrical main body and a punch integrally protruding from a top portion of the cylindrical main body. The punch is used to cut holes or indentations on the sheet of metal. The punch is prone to wear and tear. However, the conventional punch mold is integrally formed and not detachable. If the punch experiences wear and tear, the whole punch mold has to be discarded. This is wasteful; and furthermore, the typical punch integrally formed mold is not easily fabricated.

What is needed, therefore, is a detachable punch mold that overcomes the above-described shortcomings.

### BRIEF DESCRIPTION OF THE DRAWINGS

FIG. 1 is an exploded view of an embodiment of a detachable punch mold according to the present disclosure.

FIG. 2 is similar to FIG. 1, but viewed from another aspect.

FIG. 3 is an assembled view of FIG. 1.

FIG. 4 illustrates a punch mold according to the prior art.

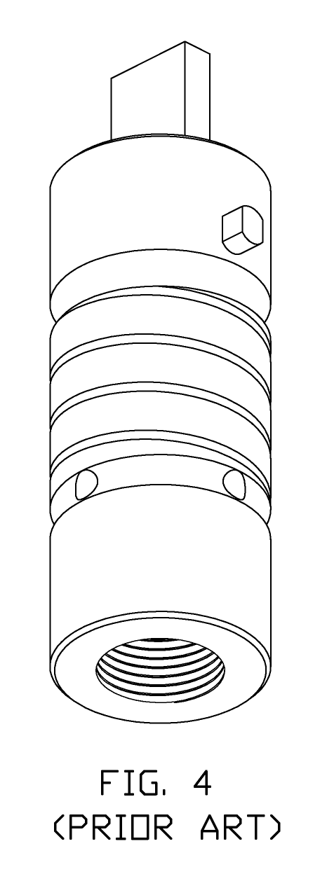

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

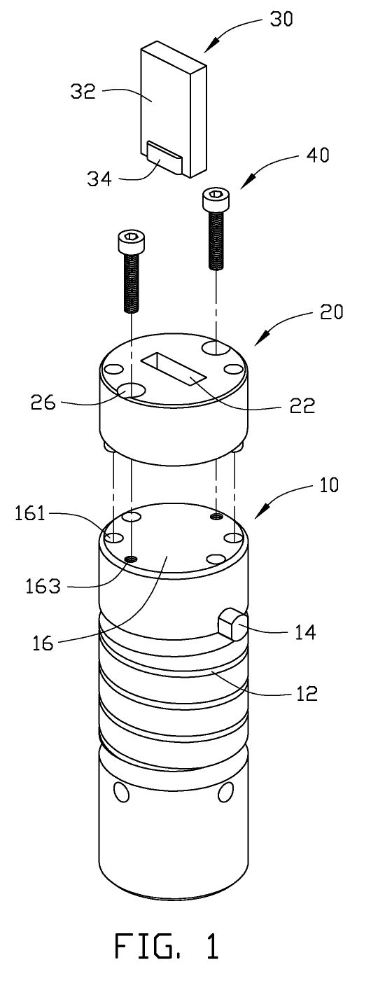

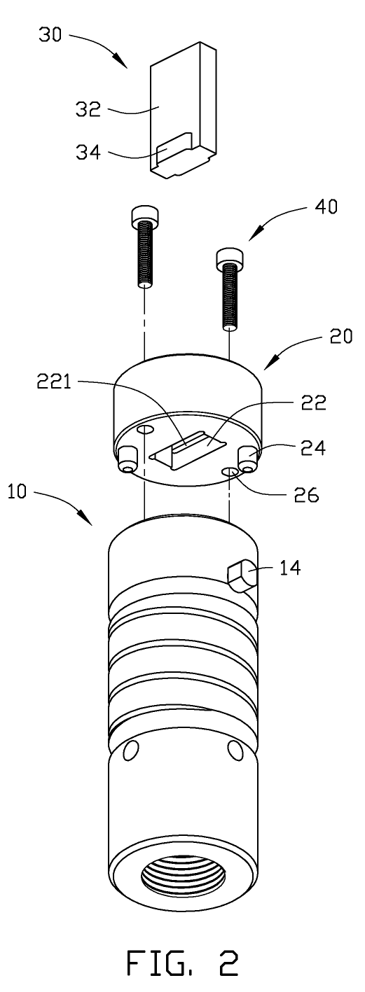

Referring to FIGS. 1 and 2, an embodiment of a detachable punch mold includes a mold base 10, a clamp member 20, a punch 30, and a pair of fastening members 40. The mold base 10, the clamp member 20 and the punch 30 are detachable parts of the punch mold. A flange of the punch 30 can be used to cut a sheet of metal.

The mold base 10 has a handle portion 12 with a spiral groove. A dowel pin 14 protrudes from an exterior surface of the mold base 10 above the handle portion 12. The dowel pin 14 is configured to facilitate installing the punch mold to a punch press machine (not shown). A pair of guiding holes 161 and a pair of screw holes 163 are defined in a top portion of the mold base 10.

The clamp member 20 is cylinder-shaped. A diameter of the cylindrical clamp member 20 is substantially equal to that of the mold base 10, and a height of the clamp member 20 is shorter than that of the mold base 10. A holding slot 22 is defined through the clamp member 20 for receiving the punch 30. The holding slot 22 includes a wide entrance portion at a bottom of the clamp member 20 and a narrow restricting portion above the entrance portion. A resisting surface 221 is formed between the wide entrance portion and the narrow restricting portion in the holding slot 22. A pair of guiding posts 24 protrudes from a bottom of the clamp member 20 corresponding to the guiding holes 161 of the mold base 10. A pair of through holes 26 is defined in the clamp member 20 corresponding to the fastening members 40. A height of each of the fastening members 40 is greater than that of the clamp member 20.

The punch 30 includes a rectangular or other shaped main body 32 and a pair of securing protrusions 34 protruding from two sides of a lower portion of the main body 32. Base surfaces of the securing protrusions 34 and the main body 32 lie on a same plane. The main body 32 of the punch 30 is receivable in the narrow restricting portion of the holding slot 22 of the clamp member 20. The securing protrusions 34 are engageable in the wide entrance portion of the holding slot 22 of the clamp member 20.

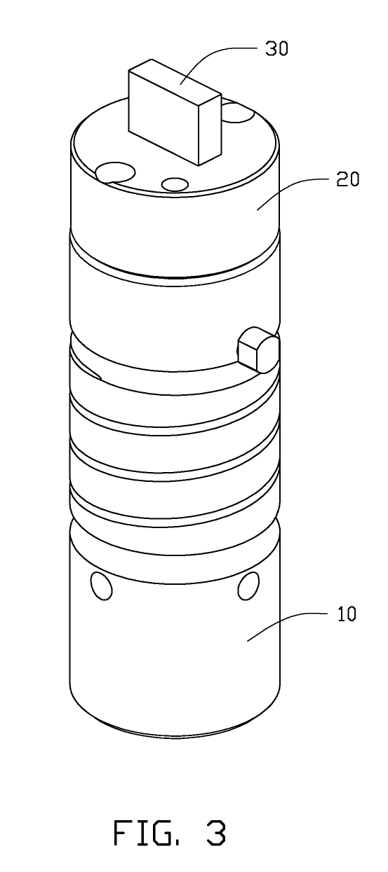

Referring to FIG. 3, in assembly, the punch 30 extends through the holding slot 22 from the lower entrance portion of the holding slot 22. The main body 32 of the punch 30 is engaged in the narrow restricting portion of the holding slot 22. The securing protrusions 34 are engaged in the entrance portion of the holding slot 22 and resisted by the resisting surface 221 in the holding slot 22. Thereby the punch 30 is prevented from being pulled out of the clamp member 20. The guiding posts 24 are inserted in the guiding holes 161 of the mold base 10, and the through holes 26 of the clamp member 20 are aligned with the screw holes 163 of the mold base 10. The fastening members 40 extend through the through holes 26 of the clamp member 20 and then securely engaged with the screw holes 163 of the mold base 10, thus securing the punch 30 and the clamp member 20 to the mold base 10.

If the punch 30 of the punch mold becomes abraded, the fastening members 40 are taken off, and the clamp member 20 and the punch 30 are detached from the punch mold. It is easy to install and replace a new punch.

In the embodiment, the appearance and function of the punch mold of the present disclosure is unchanged relative to the conventional punch mold. Furthermore, the punch mold of the present disclosure is made of detachable parts. Each of the parts can be easily formed, and each of the parts can be used in other molds. The punch mold can be widely used in currently used equipment and provide cost-savings.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

What is claimed is:

1. A detachable punch mold comprising:
a mold base;
a clamp member detachably attached to the mold base, the clamp member having a bottom and a top and a slot extending from the bottom to the top;
a punch extending through the slot from the bottom to the top along a first direction and detachably attached to the mold base;
wherein the clamp member and the punch engaged with the clamp member moves along a second direction opposite to the first direction to be attached on the mold base.

2. The detachable punch mold of claim 1, further comprising at least a fastening member that secures the clamp member and the punch to the mold base.

3. The detachable punch mold of claim 1, wherein the punch comprises a main body and at least a securing protrusion protruding from the main body, and the securing protrusion is engaged in the slot and prevents the punch to be pulled out from the top of the slot.

4. The detachable punch mold of claim 3, wherein a resisting surface is located in the slot and resists against the securing protrusion.

5. The detachable punch mold of claim 4, wherein the slot of the clamp member comprises a wide entrance portion corresponding to the securing protrusion of the punch and a narrow restricting portion for receiving the main body of the punch therein.

6. The detachable punch mold of claim 6, wherein the resisting surface in the slot is formed between the wide entrance portion and the narrow restricting portion.

7. The detachable punch mold of claim 1, wherein both of the mold base and the clamp member are cylinder-shaped.

8. The detachable punch mold of claim 7, wherein a diameter of the mold base is equal to that of the clamp member, a height of the mold base is greater than that of the clamp member.

9. The detachable punch mold of claim 1, wherein at least one guiding hole is defined in a top portion of the mold base, and at least one guiding post protrudes from a bottom surface of the clamp member and engaged in the at least one guiding hole.

10. A detachable punch mold comprising:
a mold base;
a clamp member with a slot defined therein;
a punch partially engaged in the slot of the clamp member and partially protruding out from the clamp member; and
at least one fastening member that securely attaches the clamp member and the punch to the mold base;
wherein the clamp member and the punch are both detachably attached to the mold base.

11. The detachable punch mold of claim 10, wherein the punch comprises a main body and at least a securing protrusion protruding from the main body, the securing protrusion is engaged in the slot and prevents the punch from being removed from the slot along a direction.

12. The detachable punch mold of claim 11, wherein a resisting surface is located in the slot and resists against the securing protrusion.

13. The detachable punch mold of claim 10, wherein both of the mold base and the clamp member are cylinder-shaped.

14. The detachable punch mold of claim 13, wherein a diameter of the mold base is equal to that of the clamp member, a height of the mold base is greater than that of the clamp member.

15. The detachable punch mold of claim 10, wherein at least one guiding hole is defined in a top portion of the mold base, and at least one guiding post protrudes from a bottom surface of the clamp member and engaged in the at least one guiding hole.

16. The detachable punch mold of claim 15, wherein at least one through hole is defined in the clamp member, at least one screw hole is defined in the top portion of the mold base, the at least one through hole is aligned with the at least one screw hole after the at least one guiding post is engaged in the at least one guiding hole, and the at least one fastening member extends through the through hole and engaged with the screw hole for securing the clamp member on the mold base.

17. The detachable punch mold of claim 10, wherein a dowel pin protrudes from an exterior surface of the mold base.
